(19) United States
(12) Patent Application Publication
(10) Pub. No.: US 2011/0206587 A1
(43) Pub. Date: Aug. 25, 2011

(54) Method for the Separation of NOx from a Gas Stream Containing Epoxy

(75) Inventor: Torsten Berndt, Leinefelde (DE)

(73) Assignee: Zylum Beteiligungsgesellschaft mbH & Co. Patente II KG, Schoenefeld/Waltersdorf (DE)

(21) Appl. No.: 12/999,689

(22) PCT Filed: Jun. 16, 2009
(86) PCT No.: PCT/EP09/57464

§ 371 Date: May 13, 2011

(30) Foreign Application Priority Data
Jun. 17, 2008 (DE) 10 2008 028 760.1

(51) Int. Cl. B01D 53/14; B01D 53/02; B01D 53/72; B01D 53/56

(52) U.S. Cl. 423/235; 95/232; 95/129

(57) ABSTRACT

A method is provided for separation of nitrogen oxides (NOₓ) from an epoxide-containing gas stream. The separation of nitrogen oxides (NOₓ) is performed by gas-liquid sorption and/or by gas-solid sorption.

### CROSS-REFERENCE TO RELATED APPLICATIONS

This application is a Section 371 of International Application No. PCT/EP2009/057464, filed Jun. 16, 2009, which was published in the German language on Dec. 30, 2009, under International Publication No. WO 2009/156305 A3 and the disclosure of which is incorporated herein by reference.

### BACKGROUND OF THE INVENTION

The invention relates to a method for the separation of nitrogen oxides (NOₓ) from a gas stream containing epoxy, in particular to prevent a further reaction of the NOₓ with the epoxy in the gas stream.

Epoxides are basic materials of the chemical industry and are produced and processed in large quantities. Due to their high reactivity, they represent important starting substances for the production of a large number of products.

In previous years it was possible to make epoxides available by the oxidation of olefins in a homogeneous gas-phase reaction. Such a method is described for the first time in International patent application publication No. WO 02/20502 A1. Here, a gas stream of ozone and NO₂ (and/or NO) is used as an oxidant, in order to allow the conversion of olefins to epoxides in a homogeneous gas-phase reaction under mild reaction conditions without use of a catalyst. A refinement of this method for epoxidation of olefins in a homogeneous gas-phase reaction is described in German published patent application DE 10 2007 039 874.5.

In the cited methods, ozone and NO₂ are used for the epoxidation step, wherein NO₂ in the off gas leaves the reactor unchanged together with the formed epoxide and non-converted olefins.

NO₂ itself represents a relatively strong oxidant and can react with the formed epoxide, as well as non-converted olefin. According to DE 10 2007 039 874.5, the reaction times of the epoxidation (and thus the maximum contact times) preferably lie at 1 ms to 250 ms. Considering the reaction temperature, the resulting reaction of the formed epoxide or the non-converted olefin with NO₂ in the reactor itself is negligible.

It has been shown, however, that the NO₂ also reacts after leaving the reactor with the formed epoxide as well as non-converted olefin with formation of disruptive by-products. These secondary reactions naturally also lead to a reduction of the yield of the epoxide.

Starting from the kinetic data from S. Jaffe, Chem. React. Urban Atmos.; Proc. Symp. 1969, pg. 103 (1971), the contact times of NO₂ with the epoxide must equal less than 10 sec, in order to keep the losses at less than 5%. (Epoxide: ethylene oxide; pressure: 250-1000 mbar; mole fraction of NO₂: 2 vol. %; mole fraction of epoxide: 1 vol. %, room temperature). So that the losses of epoxide equal less than 1%, the contact times should equal less than 2 seconds. Our studies can confirm the reactivity of NO₂ specified in the literature with respect to the formed epoxide.

Thus there is a need for a method that suppresses the formation of these disruptive by-products.

### BRIEF SUMMARY OF THE INVENTION

Thus, the object forming the basis of the present invention is to provide a method which allows the fastest possible and nearly complete separation of nitrogen oxides from an epoxide-containing gas stream.

According to the invention, this object is achieved by a method for the separation of NOₓ from an epoxide-containing gas stream, in which the separation of NOₓ is performed by gas-liquid sorption and/or by gas-solid sorption.

By the term “sorption,” within the scope of the present invention, should be understood both an adsorption and an absorption.

The accumulation of materials on the surface of solid bodies or liquids, generally at the boundary surface between two phases, is designated as adsorption. In contrast to this, the accumulation of materials in the interior of a solid body or a liquid is designated as absorption.

Within the scope of the present invention, the mention of “sorption” should be understood to be an adsorption process or an absorption process or a sequence of both processes.

In addition, in the sense of the present invention, the term “sorption” is to be understood as both a physisorption process and a chemisorption process. In physisorption the accumulation is performed through physical interactions, while chemisorption is characterized by an accumulation through chemical bonds.

Due to the many oxidation stages of nitrogen, there exists a plurality of nitrogen-oxygen compounds. As a collective term for these compounds, the term NOₓ was coined. Within the scope of the present invention, NOₓ should be understood to be all gaseous oxides of nitrogen. The method for the separation of NO₂/N₂O₄ (NO₂ exists in equilibrium with N₂O₄) is especially suitable. Further nitrogen oxides that should fall under the term NOₓ within the scope of the present invention are, in particular, the compounds N₂O₅, N₂O₃, NO, and N₂O.

The described method is suitable especially for the preparation of a gas stream, which is obtained in the method described at the outset for the oxidation of olefins to epoxides with ozone and NO₂. The application of the separation process, however, is in no way limited to gas streams obtained in this way. Instead, the method is suitable generally for the separation of NOₓ from epoxide-containing gas streams.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a graphical representation of the breakthrough curve of the separation of NO₂ from a propylene oxide-containing gas stream by liquid-gas sorption according to Example 1; and

FIG. 2 is a graphical representation of the breakthrough curve of the separation of NO₂ from a propylene oxide-containing gas stream by gas-solid sorption according to Example 2.

### DETAILED DESCRIPTION OF THE INVENTION

It has been shown that, by sorption on liquid and/or solid phase, such a quick separation of the NOₓ from an epoxide-containing gas stream is made possible, that the formation of undesired oxidation products is effectively suppressed. Here, the separation should preferably be performed in a time period of 1 to 100 sec, preferably in a time period of less than a few tens of seconds, particularly less than 10 sec. Depending on the reactivity of the epoxide (as well as a possibly present non-converted olefin), a longer or shorter time period can also be selected.

It has proven especially advantageous that no undesired conversion of the epoxide, as well as of possibly present non-converted olefin, takes place through the method. This leads to a significant increase in purity and yield of the obtained epoxide with the correspondingly associated economical advantages.

Preferably, the separation takes place at a temperature of −50 to 250° C. and at a pressure of 0.25 to 10 bar.

Advantageously, the method is carried out so that the gas stream is brought into contact with a sorbent material located in a sorption unit. In one embodiment, the sorption material is selected so that the NOₓ from the gas stream is retained in a sorption unit filled with sorbent material, while the epoxide remains in the gas stream. This allows an immediate further processing of the epoxide in the gas stream. In an alternative embodiment, both NOₓ and epoxide are retained in a sorption unit by sorption. This can be implemented, in particular, by selective chemisorption, in which NOₓ on the one hand and epoxide on the other hand are sorbed in different phases of the sorbent material and/or at different sorption places. This then makes a selective desorption of NOₓ and epoxide necessary.

For carrying out the method, it has been shown that both the gas-liquid sorption and the gas-solid sorption are suitable.

In the case of the use of gas-liquid sorption, it has proven especially advantageous if, as the washing liquid, a liquid is used, which comprises one or more basic compounds, in particular amines. It has been shown that, by the use of amines in the washing liquids, a nearly complete sorption of the NOₓ from an epoxide-containing gas stream is possible.

Tertiary amines, for example triamylamine, have been proven as especially suitable amines.

Amines having one or more alcohol groups can also be used. Here, N,N-dimethylethanolamine, N-methyl-diethanolamine, and/or triethanolamine have proven especially suitable.

The washing liquids can be used in pure form, in diluted form with solvents, or in mixtures. Ethanol, chloroform, and acetone have been proven as suitable solvents, to the extent that these are used.

Preferably, in the case of gas-liquid sorption, the sorption unit is constructed so that the washing fluid is present in a column filled with packings.

In one alternative embodiment, the separation takes place by the route of gas-solid sorption. It has been proven that especially high sorption rates for NOₓ can be achieved on modified aluminum oxide and materials of zeolite type.

KF-modified Al₂O₃ has been proven as an especially suitable modified aluminum oxide. Good results were obtained, for example, with a potassium fluoride-modified aluminum oxide, which is available under the Fluka No. 60244 and has an F-loading of approximately 5.5 mmol/g.

In one preferred embodiment, the sorbent material is made available via basic centers, for example by the use of oxides of the 2nd main group (MgO, BaO, etc.) or other bases, such as KOH, as well as their mixtures.

Basic compounds can also be used without the use of carriers.

In a further embodiment, metal oxides made of metals of the fourth main group or the secondary groups 6 to 8 are used. Especially preferred metal oxides are Mn or Pb oxides. For the use of metal oxides as the sorbent material, these are preferably used as carrier-supported, sorbent material.

All of the cited sorbent materials can also be used in arbitrary mixtures.

In summary, it can be established that, through the method according to the invention, a quick and almost complete separation of NOₓ from an epoxide-containing gas stream is made possible. It has been shown that, through the method according to the invention, a separation of the NOₓ is achieved without the epoxide found in the gas stream being subjected to undesired conversion.

The success of this method according to the invention is extremely surprising in view of the underlying separation problem. In this respect, it is to be emphasized, in particular, that epoxides are very reactive compounds, which can undergo a plurality of reactions. Just this reactivity is the reason for the many synthesis possibilities and substantiates the great economic significance of this class of compounds. The variety of reactions includes ring-opening reactions, especially with H-active compounds (H₂O and others), isomerizations, and build-up reactions. These can be performed both with acidic and basic catalysts, wherein zeolites and Al₂O₃ can serve as catalysts (see Ullmann's Encyclopedia of Industrial Chemistry, 6th edition, 1999 Electronic Release).

For the separation problem in question, the interactions of the washing liquid (or the solid) with NOₓ (and particularly NO₂) must be so strong that this is almost completely sorbed. Simultaneously, however, the epoxide found in the homogeneous mixture with NOₓ must not react, despite its high reactivity, with (or on) the sorbent material. In order to be able to guarantee correspondingly strong interactions with NOₓ, the washing liquid (or the solid) is often provided with appropriate polar groups or reactive centers. It is extremely surprising that the interactions via these polar groups or reactive centers are sufficient for separation of the NOₓ, without simultaneous reactions of the epoxide occurring.

In addition, the NOₓ itself (especially in the form of NO₂) also represents an extremely reactive species. Besides the gas-phase reactivity (which makes a rapid separation of epoxide necessary), this high reactivity also represents a problem, in this respect, in that there is the danger of a surface reaction of the NOₓ with the epoxide on the sorbent material. That it has been possible by the method according to the invention to guarantee an almost complete separation of the NOₓ from the epoxide, without it resulting in the cited secondary reactions, is extremely surprising to one skilled in the art.

The described method is suitable, in particular, for processing a gas stream resulting from a preceding gas-phase reaction. Here, the adsorbing unit can be connected directly after the reactor, optionally with intermediate connection of a cooling stage for cooling the off gasses, and can operate at the reaction pressure. The method according to the invention, however, can also operate at a higher or lower pressure in comparison with the operating pressure of the preceding reactor.

The method according to the invention can be used in an especially advantageous way for processing an NOₓ and epoxide-containing gas stream, as arises in a method for epoxidation described in WO 02/20502 A1 and in DE 10 2007 039 874.5. For use of the method according to the invention for processing such a reaction mixture, it has been shown that a complete separation of the NOₓ is possible and no undesired reactions of the epoxide as well as of the non-converted olefin take place.

In the following the invention will be described in even more detail with reference to examples:

### Example 1

### Separation of NO₂ from a Propylene Oxide-Containing Gas Stream by Liquid-Gas Sorption

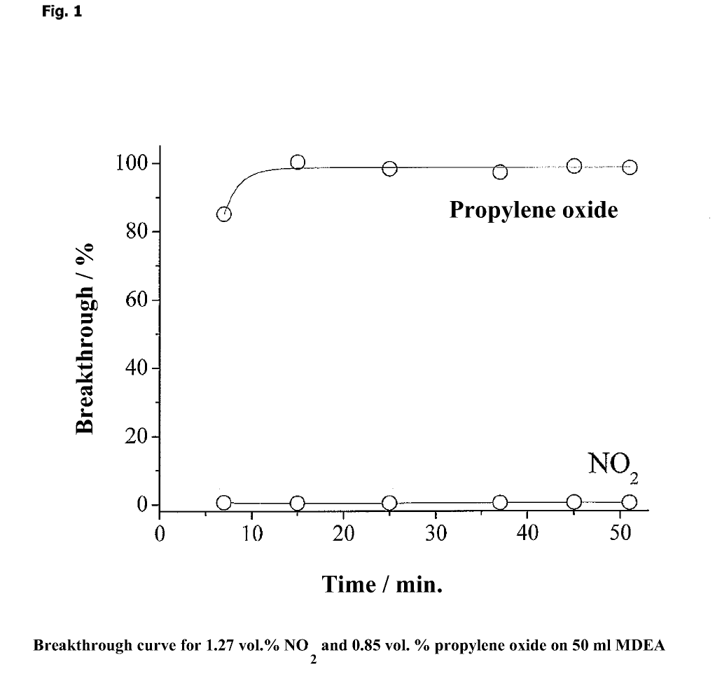

The material separation is performed at 22° C. in a sorbent gas-liquid material (column with a length of 45 cm and an inner diameter of 1.8 cm, filled with glass packings) using 50 ml N-methyl diethanolamine (MDEA). The gas stream consists of 1.27 vol. % NO₂ and 0.85 vol. % propylene oxide in oxygen with a volume flow rate of 1.0 standard liters/min. The composition of the gas is determined before and after the column by FT-IR spectroscopy. FIG. 1 shows the measured breakthrough curve; breakthrough/%=concentration after column/concentration before column×100%. According to the initial physical gas solubility of propylene oxide in MDEA, nearly 100% breakthrough is measured, 98.5% after 51 min. By GC-MS it can be shown that propylene oxide is present unchanged in MDEA. For NO₂, a breakthrough <0.5% is measured in the entire time period.

### Example 2

### Separation of NO₂ from a Propylene Oxide-Containing Gas Stream by Gas-Solid Sorption

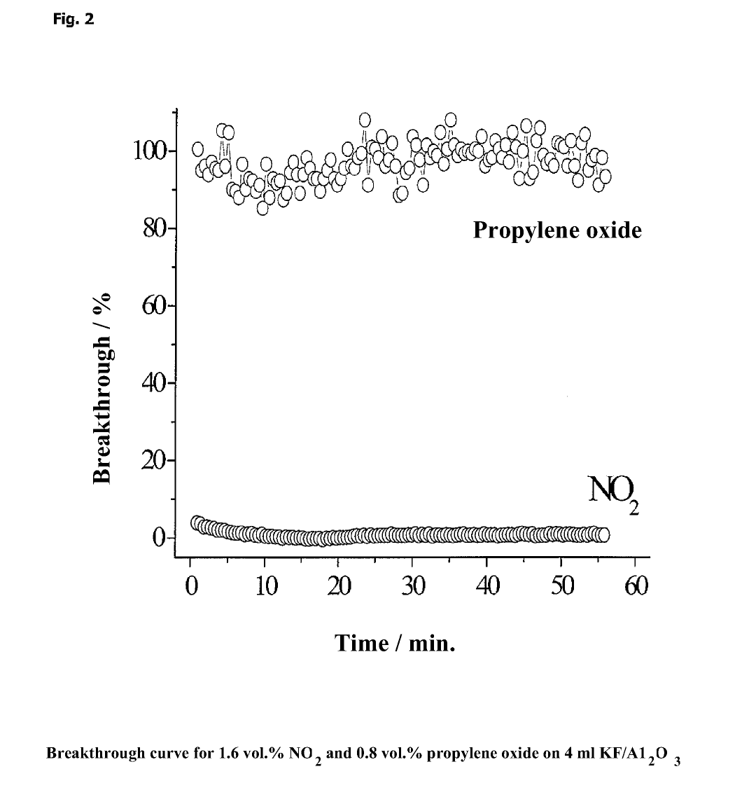

The material separation is performed at 150° C. in a gas-solid sorption unit (tube with a heated length of 10 cm and an inner diameter of 0.7 cm) using a bulk volume of 4 ml KF-modified Al₂O₃ (Fluka 60244). The gas stream consists of 1.6 vol. % NO₂ and 0.8 vol. % propylene oxide in nitrogen with a volume flow rate of 0.1 standard liters/min. The composition of the gas is determined before and after the adsorber tube by residual gas MS. For the qualitative analysis of the organic fraction of the off gas, online GC-MS was used. FIG. 2 shows the measured breakthrough curve; breakthrough/%=concentration after column/concentration before column×100% (residual gas MS analysis). For propylene oxide, an average breakthrough of 97±5% is measured. By GC-MS, besides propylene oxide, no isomerization or build-up products were detected. For NO₂, an average breakthrough of 0.8±0.7% is measured.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1.-15. (canceled)

16. A method for the separation of a nitrogen oxide (NOₓ) from an epoxide-containing gas stream, comprising separating the NOₓ from the gas stream by at least one of gas-liquid sorption and gas-solid sorption.

17. The method according to claim 16, wherein the separation is performed at a temperature of −50 to 250° C. and at a pressure of 0.25 to 10 bar.

18. The method according to claim 16, wherein the NOₓ separated from the gas stream is retained in a sorption unit and the epoxide remains in the gas stream.

19. The method according to claim 16, wherein both the NOₓ and the epoxide are separated from the gas steam and retained in a sorption unit.

20. The method according to claim 19, wherein the separation of the NOₓ and the epoxide is performed by selective chemisorption in different phases of a sorbent material and/or at different sorption places.

21. The method according to claim 16, wherein the separation is performed by gas-liquid sorption.

22. The method according to claim 21, wherein the gas-liquid sorption is performed by using a washing liquid comprising at least one basic compound.

23. The method according to claim 22, wherein the at least one basic compound comprises at least one amine.

24. The method according to claim 23, wherein the at least one amine comprises a tertiary amine.

25. The method according to claim 23, wherein the at least one amine has at least one alcohol group.

26. The method according to claim 23, wherein the amine is selected from N,N-dimethylethanolamine, N-methyl diethanolamine and triethanolamine.

27. The method according to claim 26, wherein the amine comprises N-methyl diethanolamine.

28. The method according to claim 16, wherein the separation is performed by gas-solid sorption.

29. The method according to claim 28, wherein the gas-solid sorption is performed using a sorbent material comprising at least one of a modified aluminum oxide and a zeolite type material.

30. The method according to claim 28, wherein the gas-solid sorption is performed using a sorbent material comprising a metal oxide.

31. The method according to claim 30, wherein the metal oxide is selected from oxides of main group 2 metals.

32. The method according to claim 31, wherein the metal oxide is selected from MgO and BaO.

33. The method according to claim 30, wherein the metal oxide is selected from oxides of metals of secondary groups 6, 7, 8.

34. The method according to claim 33, wherein the metal oxide is selected from manganese oxides and lead oxides.
